(19) United States
(12) Patent Application Publication
(10) Pub. No.: US 2005/0174310 A1
(43) Pub. Date: Aug. 11, 2005

(54) Low power driving in a liquid crystal display

(75) Inventors: Jih-Fong Huang, Hsinchu County (TW); Huan-Hsin Li, Miaoli County (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: AU Optronics Corporation

(21) Appl. No.: 10/747,068

(22) Filed: Dec. 30, 2003

(51) Int. Cl. G09G 3/36

(52) U.S. Cl. 345/87; 345/204

(57) ABSTRACT

A drive method for a liquid crystal display device that comprises providing an array of pixels formed in rows and columns, sequentially scanning odd-numbered rows of pixels during a first half of a frame period, and sequentially scanning even-numbered rows of pixels during a second half of the frame period.

### DESCRIPTION OF THE INVENTION

1. Field of the Invention

This invention relates in general to a liquid crystal display (“LCD”) device and, more particularly, to a drive method and a drive circuit for an LCD device.

2. Background of the Invention

A liquid crystal display (“LCD”) device in the art may be driven by line inversion or dot inversion. In driving an LCD device with line inversion, the polarity of a source signal is inverted every line of gates during a frame time. In driving an LCD device with dot inversion, the polarity of a source signal is inverted not only every line of the gates, but also every line of sources during a frame time.

FIG. 1A is a schematic diagram of a drive circuit 10 in the art for an LCD device 20. For simplicity, it is assumed that LCD device 20 uses a dot inversion scheme and includes an 8×8 matrix of pixels 22. In reality, for example, a display area of a LCD device may include 1280×1024 pixels elements, respectively the horizontal and vertical resolutions of the LCD device. Drive circuit 10 includes a gate driver 12, a source driver 14, and a controller 16. Although not specifically shown, an exemplary pixel 22 is formed adjacent to an intersection of one of gate lines 12-2 and one of source lines 14-2 formed approximately orthogonal to the gate lines 12-2. Each of the pixels 22 is driven by a corresponding transistor (not shown) including a gate (not shown) coupled to a corresponding gate line 12-2 and a source (not shown) coupled to a corresponding source line 14-2. In the particular embodiment, since dot inversion is used, a “+” or “−” sign shown to pixels 22 indicates a polarity, that is, positive or negative polarity of a source signal to be applied upon one of pixels 22 with respect to a common voltage V_{COM.}

FIG. 1B is a schematic timing diagram of drive circuit 10 shown in FIG. 1A. Controller 16 provides a start pulse SP to initiate a frame period. A clock signal CLK is generated in response to the start pulse SP. Pixels 22 are activated successively row by row through gate lines 12-2 in response to a rising edge of a clock signal CLK. Specifically, first, second, third gate lines G₁, G₂, G₃ and so forth are selected in sequence. Whenever a row of pixels 22 are activated, source signals are provided from source driver 14 to the row of pixels 22. A display corresponding to the source signal provided during the frame period is accordingly provided.

FIG. 1C is a diagram showing an output signal of source driver 14 of drive circuit 10 shown in FIG. 1A. For line inversion and dot inversion alike, the transition of the polarity of a source signal is required at every gate line. However, frequent transition of voltage polarity may adversely result in large power consumption.

### SUMMARY OF THE INVENTION

Accordingly, the present invention is directed to a display device and a method of display that obviate one or more of the problems due to limitations and disadvantages of the related art.

To achieve these and other advantages, and in accordance with the purpose of the invention as embodied and broadly described, there is provided a drive method for a liquid crystal display device that comprises providing an array of pixels formed in rows and columns, sequentially scanning odd-numbered rows of pixels during a first half of a frame period, and sequentially scanning even-numbered rows of pixels during a second half of the frame period.

In one aspect, the method further comprises providing a signal of a first polarity to the odd-numbered rows of pixels in sequence during the first half, and providing a signal of a second polarity to the even-numbered rows of pixels in sequence during the second half.

In another aspect, the method further comprises during the first half providing a signal of a first polarity in sequence to the odd-numbered rows of pixels at odd-numbered columns, and providing a signal of a second polarity in sequence to the odd-numbered rows of pixels at even-numbered columns.

In still another aspect, the method further comprises during the second half providing a signal of a first polarity in sequence to the even-numbered rows of pixels at even-numbered columns, and providing a signal of a second polarity in sequence to the even-numbered rows of pixels at odd-numbered columns.

Also in accordance with the present invention, there is provided a drive method for a liquid crystal display device that comprises providing an array of pixels formed in rows and columns, providing a first signal to activate a first half of a frame period, providing a plurality of first pulses and a plurality of second pulses, each of the second pulses following a corresponding one of the first pulses, sequentially activating odd-numbered rows of pixels during the first half in response to a corresponding one of the first pulses, sequentially inactivating even-numbered rows of pixels during the first half in response a corresponding one of the second pulses, providing a second signal to activate a second half of the frame period, sequentially activating even-numbered rows of pixels during the second half in response to a corresponding one of the first pulses, and sequentially inactivating odd-numbered rows of pixels during the second half in response a corresponding one of the second pulses.

Still in accordance with the present invention, there is provided a drive circuit for a liquid crystal display device including an array of pixels formed in rows and columns that comprises at least one source driver further comprising a plurality of source lines formed in parallel to each other, each of the source lines being coupled to a corresponding column of pixels, at least one gate driver further comprising a plurality of gate lines formed in parallel to each other and orthogonal to the source lines, each of the gate lines being coupled to a corresponding row of pixels, and a controller providing a first signal to sequentially activate a scan of odd-numbered rows of pixels through corresponding gate lines during a first half of a frame period, and providing a second signal to sequentially activate a scan of even-numbered rows of pixels through corresponding gate lines during a second half of the frame period.

Additional objects and advantages of the invention will be set forth in part in the description which follows, and in part will be obvious from the description, or may be learned by practice of the invention. The objects and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

The accompanying drawings, which are incorporated in and constitute a part of this specification, illustrate several embodiments of the invention and together with the description, serve to explain the principles of the invention.

### BRIEF DESCRIPTION OF THE DRAWINGS

FIG. 1A is a schematic diagram of a conventional drive circuit for a liquid crystal display (“LCD”) device;

FIG. 1B is a schematic timing diagram of the drive circuit shown in FIG. 1A;

FIG. 1C is a diagram showing an output signal of a source driver of the drive circuit shown in FIG. 1A;

FIG. 2A is a schematic diagram of a drive circuit for a liquid crystal display (“LCD”) device in accordance with one embodiment of the present invention;

FIG. 2B is a schematic timing diagram of the drive circuit shown in FIG. 2A in accordance with one embodiment of the present invention; and

FIG. 2C is a diagram showing an output signal of a source driver of the drive circuit shown in FIG. 1A in accordance with one embodiment of the present invention.

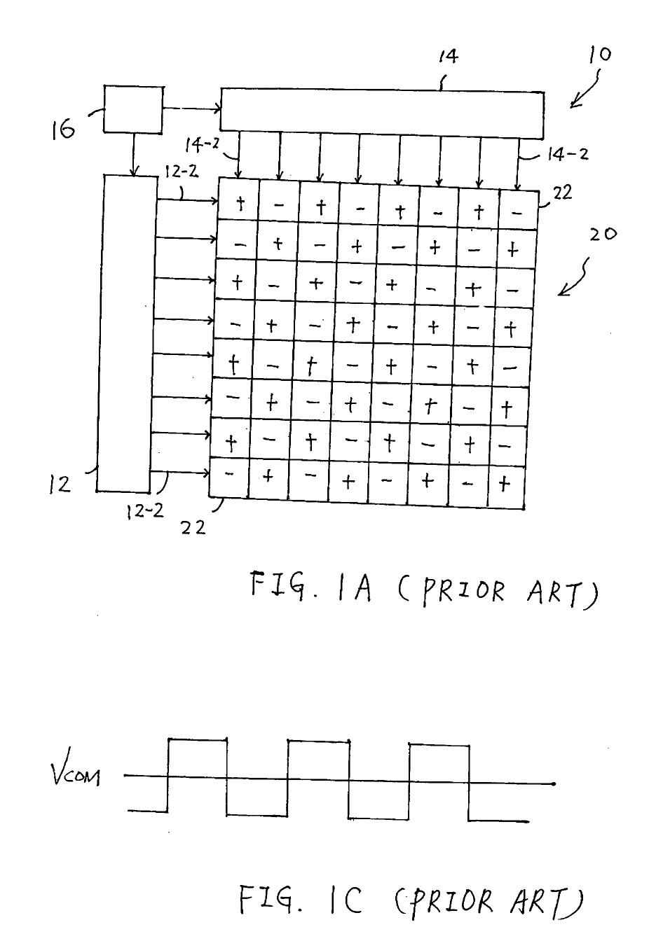

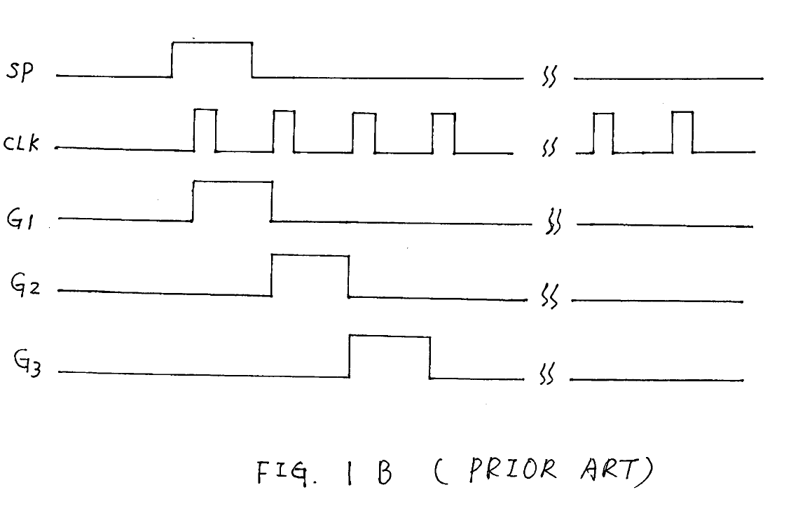

### DESCRIPTION OF THE EMBODIMENTS

Reference will now be made in detail to the present embodiment of the invention, an example of which is illustrated in the accompanying drawings. Wherever possible, the same reference numbers will be used throughout the drawings to refer to the same or like parts.

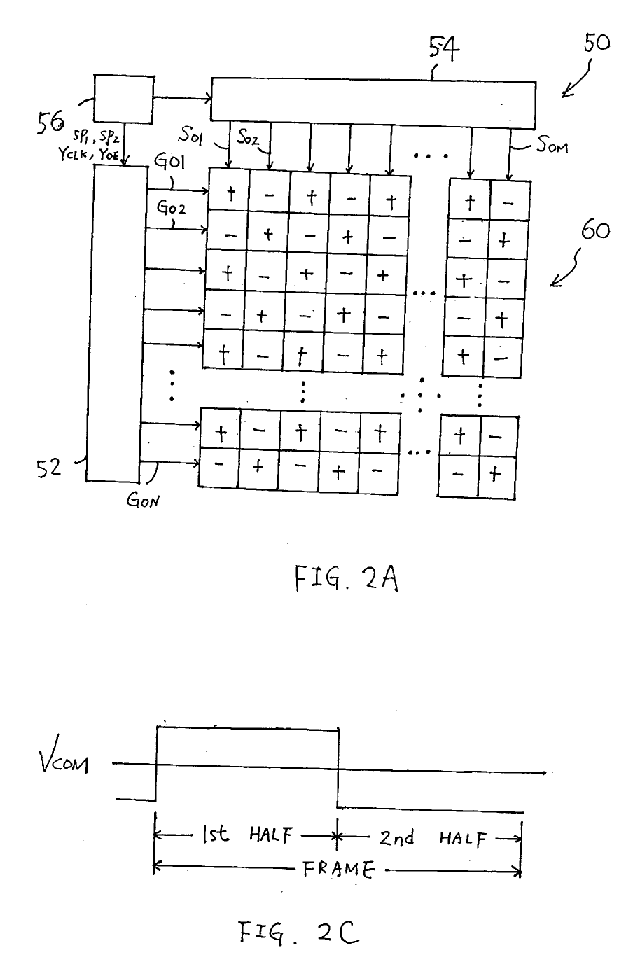

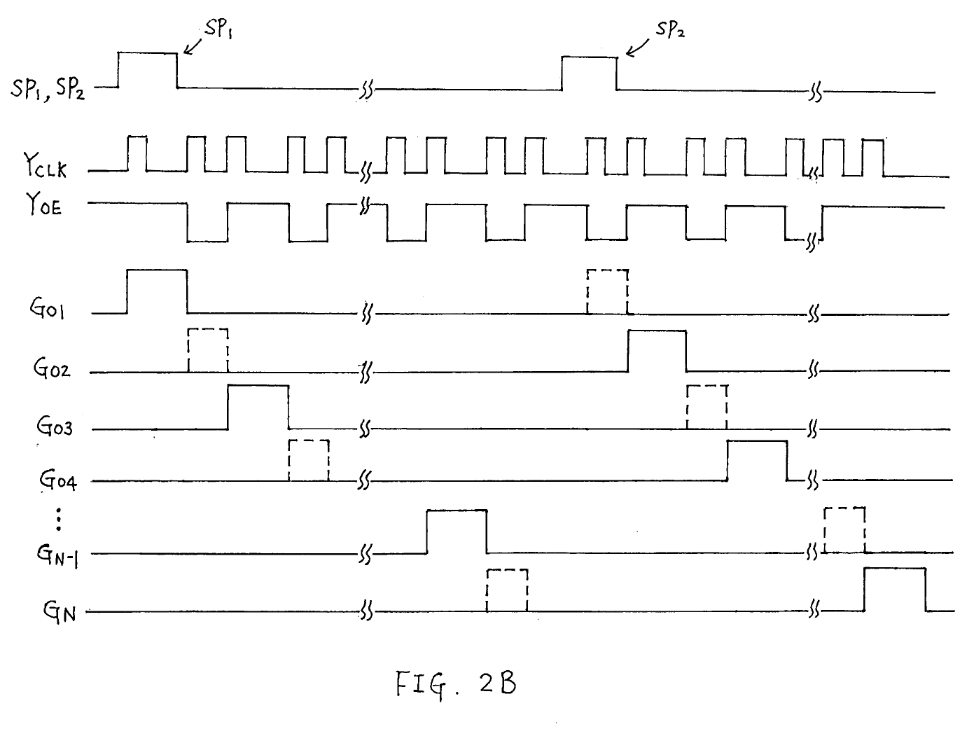

FIG. 2A is a schematic diagram of a drive circuit 50 for a liquid crystal display (“LCD”) device in accordance with one embodiment of the present invention. Drive circuit 50 serves to drive a matrix of pixels 60 of a LCD device formed in N rows and M columns, N and M being integers. Drive circuit 50 includes at least one gate driver 52, at least one source driver 54 and a controller 56. Gate driver 52 includes a plurality of gate lines G₀₁, G₀₂ . . . G_{N} formed in parallel to each other. Each of gate lines G₀₁, G₀₂ . . . G_{N} is coupled to a corresponding row of pixels 60. Source driver 54 includes a plurality of source lines S₀₁, S₀₂ . . . S_{M} formed in parallel to each other and orthogonal to gate lines G₀₁, G₀₂ . . . G_{N}. Each of source lines S₀₁, S₀₂ . . . S_{M} is coupled to a corresponding column of pixels 60. Controller 16 provides a first signal SP₁ to sequentially activate a scan of odd-numbered rows of pixels 60 through corresponding gate lines 52 during a first half of a frame period, and provides a second signal SP₂ to sequentially activate a scan of even-numbered rows of pixels 60 through corresponding gate lines 52 during a second half of the frame period.

Controller 56 also provides a clock signal Y_{CLK} and an output enable signal Y_{OE} to enable the selection of odd-numbered rows of pixels 60 during the first half and selection of even-numbered rows of pixels 60 during the second half, as will be discussed in detail below with reference to FIG. 2B. FIG. 2B is a schematic timing diagram of drive circuit 50 shown in FIG. 2A in accordance with one embodiment of the present invention. The signal Y_{CLK} includes first pulses 70 and second pulses 80. Each of second pulses 80 follows a corresponding one of first pulses 70. The signal Y_{OE} is logically high in response to one of first pulses 70, and becomes logically low in response to one of second pulses 80. The logically high level of the signal Y_{OE} enables selection of a corresponding gate line G₀₁, G₀₂ . . . or G_{N}, and the logically low level of the signal Y_{OE} disables selection of a corresponding gate line G₀₁, G₀₂ . . . or G_{N}. Specifically, for example, during the first half activated in response to the first signal SP₁, a first gate line G₀₁ is selected in response to a first pulse 70 and a high level Y_{OE}, and a second gate line G₀₂ is not selected (shown in dotted lines) in response to a low level Y_{OE}. During the second half activated in response to the second signal SP₂, a first gate line G₀₁ is not selected (shown in dotted lines) in response to a low level Y_{OE}, and a second gate line G₀₂ is selected in response to a first pulse 70 and a high level Y_{OE}.

FIG. 2C is a diagram showing an output signal of source driver 54 of drive circuit 50 shown in FIG. 2A in accordance with one embodiment of the present invention. For line inversion, source driver 54 provides a signal of a first polarity to odd-numbered rows of pixels 60 in sequence during the first half, and provides a signal of a second polarity to even-numbered rows of pixels 60 in sequence during the second half. An output of source driver 54 during the first half is kept at the first polarity, for example, a positive voltage level with respect to a common voltage V_{COM}, and during the second half is kept at the second polarity, for example, a negative voltage level with respect to V_{COM}.

For dot inversion, during the first half source driver 54 provides a signal of a first polarity in sequence to the odd-numbered rows of pixels 60 at odd-numbered columns, and provides a signal of a second polarity in sequence to the odd-numbered rows of pixels 60 at even-numbered columns. During the second half source driver 54 provides a signal of a first polarity in sequence to the even-numbered rows of pixels 60 at even-numbered columns, and provides a signal of a second polarity in sequence to the even-numbered rows of pixels 60 at odd-numbered columns. As a result, outputs of source driver 54 do not change their polarities during the first half until the second half occurs, and are kept at the inverse polarities during the second half.

The present invention also provides a drive method for an LCD device. An array of pixels 60 formed in rows and columns are provided. A first signal SP, is provided to activate a first half of a frame period. A plurality of first pulses 70 and a plurality of second pulses 80 are provided. Each of second pulses 80 follows a corresponding one of first pulses 70. Odd-numbered rows of pixels 60 are sequentially activated during the first half in response to a corresponding one of first pulses 70. Even-numbered rows of pixels 60 are sequentially inactivated during the first half in response a corresponding one of second pulses 80. After all of the odd-numbered rows of pixels 60 are selected, a second signal SP₂ is provided to activate a second half of the frame period. The even-numbered rows of pixels 60 are sequentially activated during the second half in response to a corresponding one of first pulses 70. The odd-numbered rows of pixels 60 are sequentially inactivated during the second half in response a corresponding one of second pulses 80.

In one embodiment according to the present invention using line inversion, a signal of a first polarity is provided to the odd-numbered rows of pixels 60 in sequence during the first half, and a signal of a second polarity is provided to the even-numbered rows of pixels 60 in sequence during the second half.

In another embodiment according to the present invention using dot inversion, during the first half a signal of a first polarity is provided in sequence to the odd-numbered rows of pixels 60 at odd-numbered columns, and a signal of a second polarity is provided in sequence to the odd-numbered rows of pixels 60 at even-numbered columns. During the second half a signal of a first polarity is provided in sequence to the even-numbered rows of pixels 60 at even-numbered columns, and a signal of a second polarity is provided in sequence to the even-numbered rows of pixels 60 at odd-numbered columns.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

1. A drive method for a liquid crystal display device comprising:
providing an array of pixels formed in rows and columns;
sequentially scanning odd-numbered rows of pixels during a first half of a frame period; and
sequentially scanning even-numbered rows of pixels during a second half of the frame period.

2. The method of claim 1 further comprising providing a signal of a first polarity to the odd-numbered rows of pixels in sequence during the first half, and providing a signal of a second polarity to the even-numbered rows of pixels in sequence during the second half.

3. The method of claim 1 further comprising during the first half providing a signal of a first polarity in sequence to the odd-numbered rows of pixels at odd-numbered columns, and providing a signal of a second polarity in sequence to the odd-numbered rows of pixels at even-numbered columns.

4. The method of claim 1 further comprising during the second half providing a signal of a first polarity in sequence to the even-numbered rows of pixels at even-numbered columns, and providing a signal of a second polarity in sequence to the even-numbered rows of pixels at odd-numbered columns.

5. The method of claim 1 further comprising providing a first signal to activate the first half, and a second signal to activate the second half.

6. The method of claim 1 further comprising generating a signal including first pulses and second pulses, wherein each of the second pulses follows a corresponding one of the first pulses.

7. The method of claim 6 further comprising sequentially activating a scan of the odd-numbered rows of pixels during the first half in response to a corresponding one of the first pulses.

8. The method of claim 6 further comprising sequentially activating a scan of the even-numbered rows of pixels during the second half in response to a corresponding one of the first pulses.

9. The method of claim 6 further comprising sequentially inactivating a scan of the even-numbered rows of pixels during the first half in response to a corresponding one of the second pulses.

10. The method of claim 6 further comprising sequentially inactivating a scan of the odd-numbered rows of pixels during the second half in response to a corresponding one of the second pulses.

11. A drive method for a liquid crystal display device comprising:
providing an array of pixels formed in rows and columns;
providing a first signal to activate a first half of a frame period;
providing a plurality of first pulses and a plurality of second pulses, each of the second pulses following a corresponding one of the first pulses;
sequentially activating odd-numbered rows of pixels during the first half in response to a corresponding one of the first pulses;
sequentially inactivating even-numbered rows of pixels during the first half in response a corresponding one of the second pulses;
providing a second signal to activate a second half of the frame period;
sequentially activating even-numbered rows of pixels during the second half in response to a corresponding one of the first pulses; and
sequentially inactivating odd-numbered rows of pixels during the second half in response a corresponding one of the second pulses.

12. The method of claim 11 further comprising providing a signal of a first polarity to the odd-numbered rows of pixels in sequence during the first half, and providing a signal of a second polarity to the even-numbered rows of pixels in sequence during the second half.

13. The method of claim 11 further comprising during the first half providing a signal of a first polarity in sequence to the odd-numbered rows of pixels at odd-numbered columns, and providing a signal of a second polarity in sequence to the odd-numbered rows of pixels at even-numbered columns.

14. The method of claim 11 further comprising during the second half providing a signal of a first polarity in sequence to the even-numbered rows of pixels at even-numbered columns, and providing a signal of a second polarity in sequence to the even-numbered rows of pixels at odd-numbered columns.

15. The method of claim 11 further comprising providing a signal including a first state corresponding to the first pulses, and a second state corresponding to the second pulses.

16. A drive circuit for a liquid crystal display device including an array of pixels formed in rows and columns comprising:
at least one source driver further comprising a plurality of source lines formed in parallel to each other, each of the source lines being coupled to a corresponding column of pixels;
at least one gate driver further comprising a plurality of gate lines formed in parallel to each other and orthogonal to the source lines, each of the gate lines being coupled to a corresponding row of pixels; and
a controller providing a first signal to sequentially activate a scan of odd-numbered rows of pixels through corresponding gate lines during a first half of a frame period, and providing a second signal to sequentially activate a scan of even-numbered rows of pixels through corresponding gate lines during a second half of the frame period.

17. The circuit of claim 16, the source driver providing a signal of a first polarity to the odd-numbered rows of pixels in sequence during the first half, and providing a signal of a second polarity to the even-numbered rows of pixels in sequence during the second half.

18. The circuit of claim 16, during the first half the source driver providing a signal of a first polarity in sequence to the odd-numbered rows of pixels at odd-numbered columns, and providing a signal of a second polarity in sequence to the odd-numbered rows of pixels at even-numbered columns.

19. The circuit of claim 16, during the second half the source driver providing a signal of a first polarity in sequence to the even-numbered rows of pixels at even-numbered columns, and providing a signal of a second polarity in sequence to the even-numbered rows of pixels at odd-numbered columns.

20. The circuit of claim 16, the controller further providing a signal including first pulses and second pulses, wherein each of the second pulses follows a corresponding one of the first pulses.

21. The circuit of claim 20 wherein the odd-numbered rows of pixels are sequentially selected during the first half in response to the first pulses, and the even-numbered rows of pixels are sequentially selected during the second half in response to the first pulses.

22. The circuit of claim 20 wherein the even-numbered rows of pixels are sequentially inactivated during the first half in response to the second pulses.

23. The circuit of claim 20 wherein the odd-numbered rows of pixels are sequentially inactivated during the second half in response to the second pulses.

24. The circuit of claim 16, the controller further providing a signal including a first state corresponding to the first pulses, and a second state corresponding to the second pulses.
